(19) United States
(12) Patent Application Publication
(10) Pub. No.: US 2017/0200455 A1
(43) Pub. Date: Jul. 13, 2017

(54) SUGGESTED QUERY CONSTRUCTOR FOR VOICE ACTIONS

(71) Applicant: Google Inc., Mountain View, CA (US)

(72) Inventors: Vikram Aggarwal, Mountain View, CA (US); Shir Yehoshua, San Francisco, CA (US)

(73) Assignee: Google Inc., Mountain View, CA (US)

(21) Appl. No.: 14/162,046

(22) Filed: Jan. 23, 2014

(51) Int. Cl. G10L 21/00

(52) U.S. Cl. CPC G10L 21/00

(57) ABSTRACT

Methods, systems, and apparatus, including computer programs encoded on a computer storage medium, for suggesting voice actions. The methods, systems, and apparatus include actions of receiving an utterance spoken by a user, wherein the utterance (i) includes a reference to an entity, and (ii) does not include a reference to any particular voice action. Additional actions include determining a set of voice actions that are characterized as appropriate to be performed in connection with the entity and determining a subset of the voice actions based at least on user profile data associated with the user. Further actions include prompting the user to select a voice action from among the voice actions of the subset and receiving data identifying a selected voice action. Additional actions include in response to receiving the data, generating a suggested voice command for performing the selected voice action in relation to the entity.

### TECHNICAL FIELD

This disclosure generally relates to voice commands.

### BACKGROUND

A computer may perform an action in response to a voice command. For example, if a user says “NAVIGATE TO THE GOLDEN GATE BRIDGE,” a computer may provide directions to the Golden Gate Bridge.

### SUMMARY

In general, an aspect of the subject matter described in this specification may involve a process for suggesting voice actions in response to utterances that include references to entities, but do not include references to particular voice actions. As used by this specification, a “voice action” refers to an action that is performed by a system in response to a voice command, or a predetermined phrase or sequence of terms that follow predetermined grammar, from a user. A reference to a particular voice action, which may also be referred to as a “trigger term,” may be one or more specific words that trigger the system to perform the particular voice action.

The system may provide a voice interface through which a user may instruct the system to perform voice actions. However, users may not know how to effectively invoke voice actions. For example, particular voice actions may be invoked when the user speaks certain trigger terms related to the voice actions, but the user may not know how to reference a particular voice action that the user wants to invoke. In a particular example, a user may want the system to provide the user directions to the Golden Gate Bridge, but the user may not know how to verbally request that the system provide directions to the Golden Gate Bridge.

To help users invoke voice actions, the system may enable the user to initially say a reference to an entity upon which the voice action is to occur. The system may then determine voice actions that are characterized as appropriate to be performed in connection with the entity, from those voice actions determine a subset of voice actions that the user is likely to want to invoke, and then prompt the user to select a voice action to perform from the subset of voice actions.

For example, the system may enable the user to initially say “Golden Gate Bridge,” and the system may determine that for the entity “GOLDEN GATE BRIDGE,” a set of appropriate voice actions include “NAVIGATE TO,” “SEARCH FOR IMAGES ABOUT,” and “SEARCH FOR WEBPAGES ABOUT.” The system may then determine that based on user profile data for the user, when the user says an entity that is a geographical landmark, the user typically selects “NAVIGATE TO,” less commonly selects “SEARCH FOR IMAGES ABOUT,” and rarely selects “SEARCH FOR WEBPAGES ABOUT.” Accordingly, the system may determine a subset of voice actions to include the two most typically selected voice actions, “NAVIGATE TO” and “SEARCH FOR IMAGES ABOUT” in a subset of the voice actions. The system may then prompt the user to select one of the two voice commands, “NAVIGATE TO” and “SEARCH FOR IMAGES,” in the subset of the voice actions. For example, the system may output the prompt, “WOULD YOU LIKE TO ONE, NAVIGATE TO THE GOLDEN GATE BRIDGE OR TWO, SEARCH FOR IMAGES ABOUT THE GOLDEN GATE BRIDGE?”

When the user makes a selection from the subset of voice commands, the system may generate a suggested voice command for performing the selected voice action in relation to the entity. For example, if in response to the prompt “WOULD YOU LIKE TO ONE, NAVIGATE TO THE GOLDEN GATE BRIDGE OR TWO, SEARCH FOR IMAGES ABOUT THE GOLDEN GATE BRIDGE” the user says “OPTION ONE,” the system may provide an output, e.g., “PERFORMING ‘NAVIGATE TO THE GOLDEN GATE BRIDGE,” that includes a suggested voice command, “NAVIGATE TO THE GOLDEN GATE BRIDGE,” for performing the selected voice action of “NAVIGATE TO” in relation to the entity “GOLDEN GATE BRIDGE.” Accordingly, in the future, the user may say “NAVIGATE TO THE GOLDEN GATE BRIDGE” when the user wants to system to provide the user directions to the Golden Gate Bridge.

For situations in which the systems discussed here collect personal information about users, or may make use of personal information, the users may be provided with an opportunity to control whether programs or features collect personal information (e.g., information about a user's social network, social actions or activities, profession, a user's preferences, or a user's current location), or to control whether and/or how to receive content from the content server that may be more relevant to the user. In addition, certain data may be anonymized in one or more ways before it is stored or used, so that personally identifiable information is removed. For example, a user's identity may be anonymized so that no personally identifiable information can be determined for the user, or a user's geographic location may be generalized where location information is obtained (such as to a city, zip code, or state level), so that a particular location of a user cannot be determined. Thus, the user may have control over how information is collected about him or her and used by a content server.

In some aspects, the subject matter described in this specification may be embodied in methods that may include the actions of receiving an utterance spoken by a user. The utterance may (i) include a reference to an entity, and (ii) not include a reference to any particular voice action. Additional actions may include determining a set of voice actions that are characterized as appropriate to be performed in connection with the entity and determining a subset of the voice actions that are appropriate to be performed in connection with the entity based at least on user profile data associated with the user. Further actions may include prompting the user to select a voice action from among the voice actions of the subset and in response to prompting the user, receiving data identifying a selected voice action. Additional actions may include in response to receiving the data identifying the selected voice action, generating a suggested voice command for performing the selected voice action in relation to the entity.

Other versions include corresponding systems, apparatus, and computer programs, configured to perform the actions of the methods, encoded on computer storage devices.

These and other versions may each optionally include one or more of the following features. For instance, in some implementations the voice actions that are appropriate to be performed in connection with entities are pre-associated with entities in a knowledge base before the utterance is received. Determining a set of the voice actions that are appropriate to be performed in connection with the entity may include determining the voice actions that are pre-associated with the entity that is referenced by the utterance based on the knowledge base.

In certain aspects, determining a set of the voice actions that are appropriate to be performed in connection with the entity may include determining the voice actions that are appropriate to be performed in connection with the entity dynamically after the utterance is received based on the user profile data associated with the user.

In some aspects, determining a subset of the voice actions that are appropriate to be performed in connection with the entity based at least on user profile data associated with the user may include determining a selection score for a voice action of the set of voice actions based on the user profile data and selecting the voice action from the set of voice actions for inclusion in the subset of the voice actions based on the selection score.

In some implementations, does not include a reference to any particular voice action may include that the utterance does not include trigger terms associated with any particular voice action. In certain aspects, the suggested voice command is a natural language phrase that includes trigger terms for performing the voice action, as well as a reference to the entity. In some aspects, the subset of the voice actions may include only a single voice action.

The details of one or more implementations of the subject matter described in this specification are set forth in the accompanying drawings and the description below. Other potential features, aspects, and advantages of the subject matter will become apparent from the description, the drawings, and the claims.

### DESCRIPTION OF DRAWINGS

FIGS. 1 and 2 are block diagrams of example systems for suggesting voice actions in response to utterances that include references to entities, but do not include references to particular voice actions.

FIG. 3 is a flowchart of an example process for suggesting voice actions in response to utterances that include references to entities, but do not include references to particular voice actions.

Like reference symbols in the various drawings indicate like elements.

### DETAILED DESCRIPTION

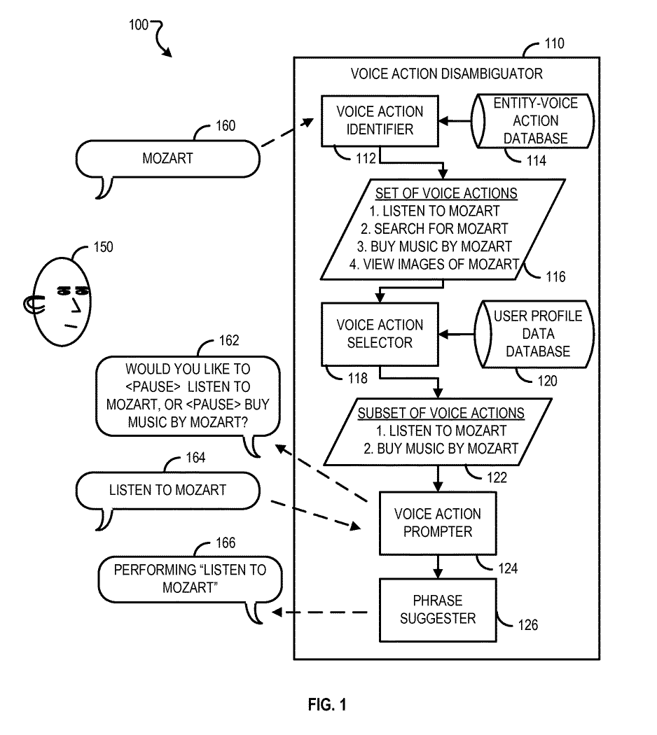

FIG. 1 is a block diagram of an example system 100 for suggesting voice actions in response to utterances that include references to entities, but do not include references to particular voice actions. Generally, the system 100 includes a voice action disambiguator 110 that suggests voice actions in response to the utterances.

The voice action disambiguator 110 includes a voice action identifier 112 that identifies a set of voice actions that are characterized as appropriate to be performed in connection with the entity, an entity-voice action database 114 that stores associations between entities and voice actions, a voice action selector 118 that determines a subset of the set of voice actions to prompt the user 150 to select a voice action from the subset, a user profile data database 120 that stores user profile data, a voice action prompter 124 that prompts the user 150 to select a voice action from the subset of voice actions, and a phrase suggester 126 that provides a suggested voice command based on the user's selection 164.

The voice action identifier 112 may receive an utterance 160 spoken by the user 150 that includes a reference to an entity and does not include a reference to any particular voice action. For example, the voice action identifier 112 may receive the utterance “MOZART” that references the entity “MOZART,” but does not include a trigger term that is associated with a particular voice action.

When the voice action identifier 112 receives the utterance 160, the voice action identifier 112 may determine a set of voice actions 116 that are appropriate to be performed in connection with the entity referenced by the utterance 160. For example, the voice action identifier 112 may characterize that the voice actions “LISTEN TO MOZART,” “SEARCH FOR MOZART,” “BUY MUSIC BY MOZART,” “VIEW IMAGES OF MOZART” are appropriate to be performed in connection with the entity “MOZART,” referenced by the utterance “MOZART,” and include the voice actions in the set of voice actions.

The voice action identifier 112 may determine the set of voice actions 116 that are characterized as appropriate to be performed in connection with the entity based on associations between the entity and voice actions. The voice action identifier 112 may receive associations between entities and voice actions from the entity-voice action database 114, determine the associations that relate to the entity referenced in the utterance 160, determine the voice actions corresponding to the associations, and include the voice actions determined to correspond to the associations in the set of voice actions 116.

For example, the voice action identifier 112 may receive associations between the entity “MOZART” and the voice actions of “LISTEN TO,” “SEARCH FOR,” “BUY MUSIC” and “VIEW IMAGES,” and receive associations between the entity “GOLDEN GATE BRIDGE” and the voice actions of “NAVIGATE TO,” “SEARCH FOR IMAGES ABOUT” and “SEARCH FOR WEBSITES ABOUT.” The voice action identifier 112 may then determine that the utterance “MOZART” references the entity “MOZART,” identify the associations between the entity “MOZART” and the voice actions of “LISTEN TO,” “SEARCH FOR,” “BUY MUSIC,” and “VIEW IMAGES” relate to the entity “MOZART,” and include the voice actions of “LISTEN TO MOZART,” “SEARCH FOR MOZART,” “BUY MUSIC BY MOZART,” and “VIEW IMAGES OF MOZART” in a set of voice actions based on the associations.

The entity-voice action database 114 may provide the voice action identifier 112 associations between entities and voice actions. For example, the associations between entities and voice actions may be pre-associated, in a knowledge base that is based on query logs from all users, machine-learning results, or manually created associations, before the utterance 160 is received. The entity-voice action database 114 may store a knowledge graph that pre-associates the entity “MOZART” and the voice actions of “LISTEN TO,” “SEARCH FOR,” “BUY MUSIC” and “VIEW IMAGES,” and pre-associates the entity “GOLDEN GATE BRIDGE” and the voice actions of “NAVIGATE TO,” “SEARCH FOR IMAGES ABOUT” and “SEARCH FOR WEBSITES ABOUT.”

The voice action selector 118 may determine a subset 122 of the set 116 of voice actions determined by the voice action identifier 112. For example, from the set of voice actions of “LISTEN TO MOZART,” “SEARCH FOR MOZART,” “BUY MUSIC BY MOZART” and “VIEW IMAGES OF MOZART,” the voice action selector 118 may determine the subset to include the voice actions of “LISTEN TO MOZART” and “BUY MUSIC BY MOZART.”

The voice action selector 118 may determine the subset 122 of voice actions based on user profile data. For example, the voice action selector 118 may only include a maximum number of the voice actions in the subset. Accordingly, the voice action selector 118 may determine the voice actions that the user 150 may most likely select based on the user profile data, and include the voice actions in the subset ranked by likelihood up to the maximum number, e.g., two, three, four, or ten, of voice actions. For example, the voice action selector 118 may only include a maximum of two voice actions in a subset, may determine based on the user profile data that the voice action of “LISTEN TO MOZART” is most likely to be selected by the user 150 and the voice action of “BUY MUSIC BY MOZART” is next most likely to be selected by the user 150, and based on the determination, include the voice actions in the subset of voice actions.

Additionally or alternatively, the voice action selector 118 may select any number of voice actions as long as the voice actions satisfy predetermined criteria. For example, the predetermined criteria may be the satisfaction of a likelihood threshold. In a particular example, the voice action selector 118 may include any particular voice action in the subset of voice actions where the voice action selector 118 determines that the particular voice action has a 30% likelihood to be selected by the user 150. Other predetermined criteria may be used as well, for example, a different likelihood threshold, e.g., 20%.

The voice action selector 118 may use additional or alternative methods of determining the voice actions to include in the subset 122 of voice actions. For example, the voice action selector 118 may select a particular voice action based on the user 150 having pre-designated that a particular type of voice action should be included in the subset 122 of voice actions when the voice action is in the set 116 of voice actions determined by the voice action identifier 112. The user's pre-designations may be part of the user profile data.

The voice action selector 118 may determine the likelihood that any particular voice action may be selected by the user 150 based on the user profile data. For situations in which the systems discussed here collect personal information about users, or may make use of personal information, the users may be provided with an opportunity to control whether programs or features collect personal information (e.g., information about a user's social network, social actions or activities, profession, a user's preferences, or a user's current location), or to control whether and/or how to receive content from the content server that may be more relevant to the user. In addition, certain data may be anonymized in one or more ways before it is stored or used, so that personally identifiable information is removed. For example, a user's identity may be anonymized so that no personally identifiable information can be determined for the user, or a user's geographic location may be generalized where location information is obtained (such as to a city, zip code, or state level), so that a particular location of a user cannot be determined. Thus, the user may have control over how information is collected about him or her and used by a content server.

The voice action selector 118 may determine the likelihood that any particular voice action may be selected by the user 150 based on user profile data that indicates historical usage of voice actions. Historical usage may indicate, for example, the number of times the user 150 has ever selected a particular voice action, the number of times the user 150 has selected the particular voice action when prompted to select between another voice action, the number of times the user 150 has selected the particular voice action in relation to a particular entity, or the number of times the user 150 has selected the particular voice action in relation to a similar entity. For example, the voice action selector 118 may determine that the voice action of “LISTEN TO” has been most frequently selected over any other voice action when a referenced entity is a famous musician and, based on the determination, determine that the voice action of “LISTEN TO” has a high likelihood to be selected by the user when an utterance references a famous musician 150.

Alternatively or additionally, the voice action selector 118 may determine the likelihood that any particular voice action may be selected by the user 150 based on user profile data that indicates likely interests of the user. For example, the user profile data may indicate that the user is likely interested in the topic “MUSIC.” Accordingly, the voice action selector 118 may determine that the voice actions of “LISTEN TO MOZART” and “BUY MUSIC BY MOZART” are related to the topic “MUSIC,” and thus determine that the voice actions have a high likelihood to be selected by the user 150.

Alternatively or additionally, the voice action selector 118 may determine from the user profile data that the user 150 frequently buys music, so the voice action of “BUY MUSIC BY MOZART” has a high likelihood to be selected by the user 150. Alternatively or additionally, the voice action selector 118 may determine from the user profile data that the user 150 has a large amount of music by Mozart in the user's music library, so the voice action of “LISTEN TO MOZART” has a high likelihood to be selected by the user 150. For an artist where the list of albums is small, the voice action selector 118 might determine that the user 150 owns all albums by the artist so it is meaningless to suggest a BUY action, and set a likelihood of “0%” to the BUY action.

The voice action prompter 124 may prompt the user 150 to select a voice action to be performed from the subset 122 of voice actions and may receive the selection 164 from the user 150. For example, based on the subset of voice actions of “LISTEN TO MOZART” and “BUY MUSIC BY MOZART,” the voice action prompter 124 may synthesize speech for a prompt 162, “WOULD YOU LIKE TO <PAUSE> LISTEN TO MOZART, OR <PAUSE> BUY MUSIC BY MOZART?” The voice action prompter 124 may then determine that the user has provided a selection 164 by saying “LISTEN TO MOZART,” and based on the user's utterance of “LISTEN TO MOZART,” determine that the user 150 has selected the voice action of “LISTEN TO MOZART” from the subset of voice actions. The voice action prompter 124 may also update the user profile data stored in the user profile data database 120 based on the selection 164 from the user 150. For example, if the user 150 selects “LISTEN TO MOZART,” the voice action prompter 124 may update the user profile data to indicate that the user 150 selected the voice action over all other voice actions for this entity “MOZART.”

In some implementations, the voice action prompter 124 may synthesize speech for a prompt 162, “WOULD YOU LIKE TO ONE, LISTEN TO MOZART OR TWO, BUY MUSIC BY MOZART?” The voice action prompter 124 may then determine that the user has provided a selection 164 by saying “ONE,” and based on the user's utterance of “ONE,” determine that the user 150 has selected the voice action of “LISTEN TO MOZART” from the subset of voice actions.

The phrase suggester 126 may generate a suggested voice command 166 for performing the selected voice action in relation to the entity. The suggested voice command 166 may include both a reference to the entity and a reference to a particular voice action. For example, in response to a selection 164 of the voice action, “LISTEN TO MOZART,” from the user 150, the phrase suggester 126 may generate the suggested voice command 166 “LISTEN TO MOZART.”

While in this particular example the suggested voice command 166 generated by the phrase suggester 126 is the same phrase as the selected voice action, the phrase suggester 126 may generate a suggested voice command 166 that is different from a selected voice action. For example, in response to a selection 164 of the voice action “LISTEN TO MOZART” by the user 150, the phrase suggester 126 may generate any one of the suggestions, “PLAY MUSIC BY MOZART,” “BEGIN PLAYING MOZART,” “START PLAYING MOZART,” or “I WANT TO HEAR MUSIC BY MOZART.”

All the suggested voice commands 166 above include a reference to the entity “MOZART” and a reference to a particular voice action, e.g., “LISTEN TO” and “PLAY MUSIC BY.” Accordingly, in the future, instead of the user 150 first saying a reference to an entity and then selecting a voice action in response to a prompt 162 to select a voice action from multiple voice actions, the user 150 may say a suggested voice command 166 to have the system 100 perform a voice action without any further prompting by the system 100. For example, in the future, the user 150 may simply say “LISTEN TO MOZART” instead of first saying “MOZART” and then saying “ONE” in response to the prompt 162 “WOULD YOU LIKE TO ONE, LISTEN TO MOZART OR TWO, BUY MUSIC BY MOZART?”

Different configurations of the system 100 may be used where functionality of the voice action identifier 112, voice action selector 118, voice action prompter 124, and phrase suggester 126 may be combined, further separated, distributed, or interchanged. The system 100 may be implemented in a single device or distributed across multiple devices.

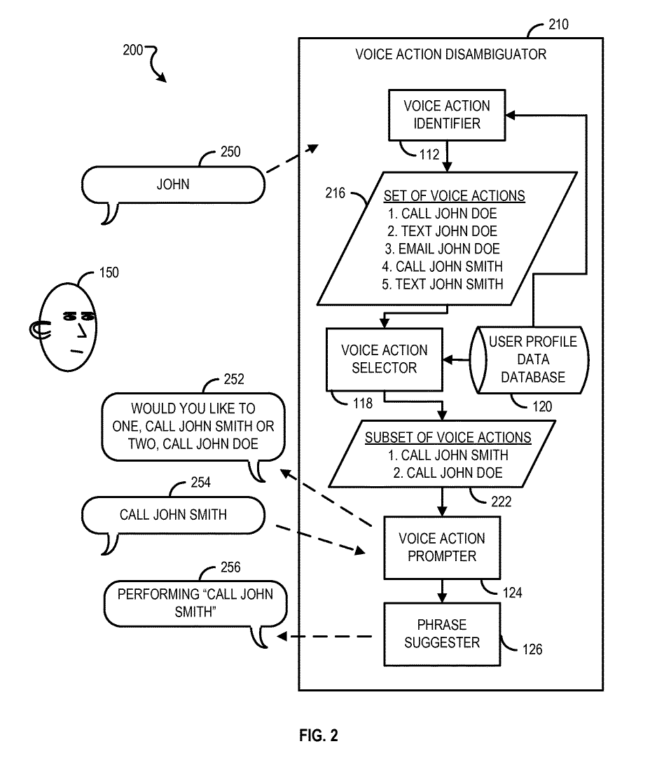

FIG. 2 is a block diagram of another example system 200 for suggesting voice actions in response to utterances that include references to entities, but do not include references to particular voice actions. Generally, the system 200 includes a voice action disambiguator 110 that suggests voice actions in response to an utterance from a user 150 that includes a reference to an entity but does not include a reference to any particular voice action.

The voice action disambiguator 110 includes a voice action identifier 112 that identifies a set of voice actions that are characterized as appropriate to be performed in connection with the entity, a voice action selector 118 that determines a subset of the set of voice actions to prompt the user 150 to select a voice action from the subset, a user profile data database 120 that stores user profile data, a voice action prompter 124 that prompts the user 150 to select a voice action from the subset of voice actions, and a phrase suggester 126 that provides a suggested voice command based on the user's selection 164.

The voice action identifier 112 may receive an utterance 160 spoken by the user 150 that includes a reference to an entity and does not include a reference to any particular voice action. For example, the voice action identifier 112 may receive the utterance “JOHN” that references an entity but does not include a trigger term that is associated with a particular voice action. In this case, the utterance may not reference an entity with enough specificity so that a specific entity may be determined to be referenced by the utterance. For example, there may be thousands of people named “JOHN” that the system 100 may know about, and there may be two contact records for individuals, “JOHN DOE” and “JOHN SMITH,” with the first name of “JOHN” that the user 150 has stored in the user's phone.

When the voice action identifier 112 receives the utterance 250, the voice action identifier 112 may determine a set of voice actions 216 that are characterized as appropriate to be performed in connection with the entity referenced by the utterance 250. For example, the voice action identifier 112 may determine that the voice actions “CALL JOHN DOE,” “TEXT JOHN DOE,” “EMAIL JOHN DOE,” “CALL JOHN SMITH,” and “TEXT JOHN SMITH” are characterized as appropriate to be performed in connection with an entity referenced by the utterance “JOHN” and include the voice actions in the set of voice actions 216.

The voice action identifier 112 may dynamically determine the set of voice actions 216 that are characterized as appropriate to be performed in connection with the entity based on user profile data. For example, the voice action identifier 112 may dynamically determine the set of voice actions 216 that are characterized as appropriate to be performed in connection with the entity based on contact records, bookmarks, or saved locations of the user that are associated with entities. The voice action identifier 112 may analyze the information that is stored in the contact records, bookmarks, or saved locations to determine voice actions for which sufficient information is available to perform the voice action in connection with the entities.

In one example, in response to receiving the utterance 250 “JOHN,” the voice action identifier 112 may receive user profile data that indicates that the user 150 has two contact records with a first name of “JOHN.” The first contact record may be for “JOHN DOE,” and may have both a phone number and e-mail address for “JOHN DOE.” The second contact record may be for “JOHN SMITH,” and may have a phone number but no e-mail address for “JOHN SMITH.” The voice action identifier 112 may identify these two contact records in the user profile data and determine that the entity “JOHN DOE” may be called, texted, or e-mailed and the entity “JOHN SMITH” may be called or texted, but not e-mailed as there is no e-mail stored in the contact record for “JOHN SMITH.” Accordingly, even though the voice action identifier 112 may not know whether “JOHN” is a reference to the entity “JOHN DOE” or the entity “JOHN SMITH,” the voice action identifier 112 may determine that a set of voice actions that are characterized as appropriate to be performed in connection with the entity includes the voice actions “CALL JOHN DOE,” “TEXT JOHN DOE,” “EMAIL JOHN DOE,” “CALL JOHN SMITH,” and “TEXT JOHN SMITH.”

In another example, in response to receiving the utterance 250 “HOME,” the voice action identifier 112 may receive user profile data that indicates that the user 150 has a saved location for an entity, “HOME,” that includes a phone number and an address. From the saved location, the voice action identifier 112 may determine that for the entity “HOME,” the phone number allows “HOME” to be called and that the address allows “HOME” to be navigated to. Accordingly, the voice action identifier 112 may determine that the set of voice actions that are characterized as appropriate to be performed in connection with “HOME” includes the voice actions of “NAVIGATE TO HOME” and “CALL HOME.”

The voice action selector 118 may receive the set of voice actions 216 and determine a subset 222 of voice actions based on user profile data. For example, similarly to as described above, the voice action selector 118 may determine the subset 222 of voice actions based on determining likelihoods that the voice actions of the set of voice actions 216 will be selected by the user 150. In a particular example, the voice action selector 118 may determine that the user 150 frequently makes phone calls and rarely sends texts or e-mails. Accordingly, the voice action selector 118 may determine that “CALL JOHN SMITH” and “CALL JOHN DOE” are the two most likely voice actions to be selected by the user 150 from the set of voice actions 216. Of these two voice actions, the voice action selector 118 may also determine that “CALL JOHN SMITH” is more likely to be performed than “CALL JOHN DOE” based on data in the user profile that indicates that the user 150 more frequently interacts with John Smith than John Doe or data that indicates that the user 150 is supposed to call John Smith, e.g., a calendar appointment.

In another example, where the reference is to a saved location “HOME,” the voice action selector 118 may determine that for references to entities that are saved locations, the voice action for “NAVIGATE TO” to the entity has a very high likelihood of being performed and that the voice action of “CALL” has a low likelihood of being performed. Accordingly, the voice action selector 118 may determine to only include a single voice action of “NAVIGATE TO HOME” in the subset of voice actions.

Similarly to as described above, the voice action prompter 124 may receive the subset 222 of voice actions, e.g., the subset of “CALL JOHN SMITH” and “CALL JOHN DOE,” provide a prompt 252 to the user 150 to make a selection 254 from the subset 222 of voice actions, e.g., output “WOULD YOU LIKE TO ONE, CALL JOHN SMITH OR TWO, CALL JOHN DOE,” and receive a selection 254 from the user 150, e.g., receive “CALL JOHN SMITH.”

In the case where the subset includes only a single voice action, e.g., “NAVIGATE TO HOME,” the voice action prompter 124 may still prompt the user 150 to select the voice action. The selection 254 of the voice action may serve as a confirmation that the user 150 wants the voice action to be performed.

Similarly to as described above, the phrase suggester 126 may then suggest a voice command for performing the selected voice action for the referenced entity. For example, the phrase suggester 126 may generate the suggested voice command 256, “CALL JOHN SMITH,” and output “PERFORMING ‘CALL JOHN SMITH.”

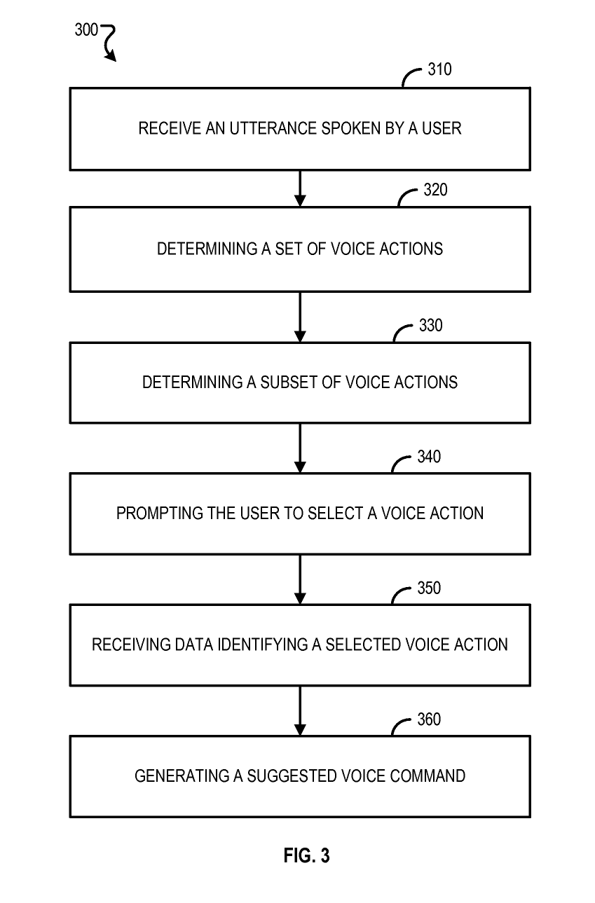

FIG. 3 is a flowchart of an example process 300 for suggesting a phrase for performing a voice action. The following describes the processing 300 as being performed by components of the system 100 that are described with reference to FIG. 1. However, the process 300 may be performed by other systems or system configurations.

The process 300 may include receiving an utterance spoken by a user (310). The utterance may include a reference to an entity and may not include a reference to a particular voice action. For example, utterances referencing well known entities, e.g., “GOLDEN GATE BRIDGE” or “MOZART,” or entities personal to the user 150, e.g., “JOHN,” “JOHN SMITH,” or “HOME,” may be received from the user 150 by the voice action identifier 112.

The process 300 may include determining a set of voice actions (320). The voice action identifier 112 may determine the entity that is referenced in the utterance, receive entity-voice action associations for the entity from an entity-voice action database 114, and determine a set of voice actions that includes the voice actions that are associated with the entity based on the entity-voice action associations. For example, for the utterance “GOLDEN GATE BRIDGE” the voice action identifier 112 may receive information from a knowledge graph that associates the entity the Golden Gate Bridge with the voice actions of “NAVIGATE TO,” “SEARCH FOR IMAGES,” and “SEARCH FOR WEBPAGES,” and determine that a set of voice actions includes “NAVIGATE TO GOLDEN GATE BRIDGE,” “SEARCH FOR IMAGES OF GOLDEN GATE BRIDGE,” and “SEARCH FOR WEBPAGES FOR GOLDEN GATE BRIDGE.”

Additionally or alternatively, the voice action identifier 112 may dynamically determine voice actions that may be characterized as appropriate to be performed in connection with the entity. For example, the voice action identifier 112 may identify for the utterance “HOME” that user profile data from a user profile data database 120 indicates that the user 150 has a saved location that is named “HOME” and has an associated address and phone number. Accordingly, the voice action identifier 112 may determine that the voice actions of “NAVIGATE TO” and “CALL” may be characterized as appropriate to be performed in connection with the entity named “HOME,” and determine that a set of voice actions includes the voice actions “NAVIGATE TO HOME” and “CALL HOME.”

The process 300 may include determining a subset of voice actions (330). The voice action selector 118 may determine a subset 122 of voice actions from the set of voice actions 116 based on user profile data from the user profile data database 120. For example, from the set of voice actions of “NAVIGATE TO GOLDEN GATE BRIDGE,” “SEARCH FOR IMAGES OF GOLDEN GATE BRIDGE,” and “SEARCH FOR WEBPAGES FOR GOLDEN GATE BRIDGE,” the voice action selector 118 may receive user profile data 120 that indicates that the user 150 requests the voice action of “NAVIGATE TO GOLDEN GATE BRIDGE” more than any other voice action in the set, that the user 150 generally requests voice actions of “NAVIGATE TO” more than any other voice action when the user says an entity that is a place of interest, e.g., a landmark, or that the user frequently visits the Golden Gate Bridge. The voice action selector 118 may also determine that, based on the user profile data, the voice action of “SEARCH FOR IMAGES OF GOLDEN GATE BRIDGE” may be more likely to be performed than the voice action of “SEARCH FOR WEBPAGES FOR GOLDEN GATE BRIDGE.” Accordingly, the voice action selector 118 may determine the subset of voice actions to include “NAVIGATE TO GOLDEN GATE BRIDGE” and “SEARCH FOR IMAGES OF GOLDEN GATE BRIDGE.”

The process may include prompting the user to select a voice action (340). The voice action prompter 124 may prompt the user 150 to make a selection 164 from the subset of voice actions. For example, for the subset of voice actions including “NAVIGATE TO GOLDEN GATE BRIDGE” and “SEARCH FOR IMAGES OF GOLDEN GATE BRIDGE,” the voice action prompter 124 may prompt the user, “WOULD YOU LIKE TO ONE, NAVIGATE TO GOLDEN GATE BRIDGE OR TWO, SEARCH FOR IMAGES OF GOLDEN GATE BRIDGE.”

The process may include receiving data identifying a selected voice action (350). In response to prompting the user 150 to make a voice action selection 164, the voice action prompter 124 may receive data that indicates a selection 164 of a voice action by the user 150. For example, the user 150 may say “OPTION ONE,” “NAVIGATE TO GOLDEN GATE BRIDGE,” or “ONE.”

The process may include generating a suggested voice command (360). The phrase suggester 126 may generate a voice command for performing the selected voice action in relation to the entity. For example, the phrase suggester 126 may determine that the selected voice action is “NAVIGATE TO GOLDEN GATE BRIDGE” and generate a voice command for the voice action in relation to the Golden Gate Bridge. The voice command may be, “NAVIGATE TO GOLDEN GATE BRIDGE,” “DIRECT ME TO GOLDEN GATE BRIDGE,” “GUIDE ME TO GOLDEN GATE BRIDGE,” or “DIRECTIONS TO GOLDEN GATE BRIDGE.” The phrase suggester 126 may preface the voice command with an introductory phrase. For example, the phrase suggester 126 may output, “PERFORMING,” “YOU COULD HAVE SAID,” “SUGGESTED VOICE COMMAND IS:,” or “VOICE COMMAND BEING PERFORMED:”

Embodiments of the subject matter, the functional operations and the processes described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible nonvolatile program carrier for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “data processing apparatus” encompasses all kinds of apparatus, devices, and machines for processing data, including by way of example a programmable processor, a computer, or multiple processors or computers. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a standalone program or as a module, component, subroutine, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Computers suitable for the execution of a computer program include, by way of example, can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few.

Computer readable media suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other steps may be provided, or steps may be eliminated, from the described processes. Accordingly, other implementations are within the scope of the following claims.

1. A computer-implemented method comprising:
receiving, by an automated text-to-speech synthesizer, an utterance spoken by a user, the utterance including a reference to an entity and no reference to any particular voice action that is associated with a physical action;
determining, by the automated text-to-speech synthesizer, a set of voice actions that are pre-associated in a knowledge base with the entity that is referenced by a transcription of the utterance, wherein the voice actions are pre-associated with the entity based on queries that were submitted by one or more other users, machine-learning results, or manually-created associations;
determining, by the automated text-to-speech synthesizer, a subset of the voice actions that are pre-associated with the entity based on user profile data associated with the user that indicates past usage of voice actions, past physical actions taken by the user, and likely interests of the user by identifying (i) voice actions, each associated with a physical action, related to at least one topic associated with the entity that is indicated by user profile data as being of interest to the user and (ii) for each of the voice actions related to the at least one topic, a frequency indicated by the user profile data that the user has initiated the physical action associated with the voice action in connection with the entity or another entity that is characterized as similar to the entity;
prompting by the automated text-to-speech synthesizer, the user to select a voice action from among the voice actions of the subset;
in response to prompting the user, receiving, by the automated text-to-speech synthesizer, data identifying a selected voice action;
in response to receiving the data identifying the selected voice action, generating, by the automated text-to-speech synthesizer, a suggested voice command for performing the physical action associated with the selected voice action in relation to the entity that is referenced by the transcription of the utterance; and
providing, by the automated text-to-speech synthesizer, a synthesized speech representation of the suggested voice command for output to the user.

2. (canceled)

3. (canceled)

4. The method of claim 1, wherein determining a subset of the voice actions that are pre-associated with the entity based on user profile data associated with the user that indicates past usage of voice actions, past physical actions taken by the user, and likely interests of the user by identifying (i) voice actions, each associated with a physical action, related to at least one topic associated with the entity and that is indicated by user profile data as being of interest to the user and (ii) for each of the voice actions related to the at least one topic, a frequency indicated by the user profile data that the user has initiated the physical action associated with the voice action in connection with the entity or another entity that is characterized as similar to the entity comprises:
determining a selection score for a voice action of the set of voice actions based on the user profile data; and
selecting the voice action from the set of voice actions for inclusion in the subset of the voice actions based on the selection score.

5. (canceled)

6. The method of claim 1, wherein the suggested voice command is a natural language phrase that includes trigger terms for performing the voice action, as well as a reference to the entity.

7. The method of claim 1, wherein the subset of the voice actions comprises only a single voice action.

8. A system comprising:
one or more computers; and
one or more storage devices storing instructions that are operable, when executed by the one or more computers, to cause the one or more computers to perform operations comprising:
receiving, by an automated text-to-speech synthesizer., an utterance spoken by a user, the utterance including a reference to an entity and no reference to any particular voice action that is associated with a physical action;
determining by the automated text-to-speech synthesizer., a set of voice actions that are pre-associated in a knowledge base with the entity that is referenced by a transcription of the utterance, wherein the voice actions are pre-associated with the entity based on queries that were submitted by one or more other users, machine-learning results, or manually-created associations;
determining, by the automated text-to-speech synthesizer, a subset of the voice actions that are pre-associated with the entity based on user profile data associated with the user that indicates past usages of voice actions, past physical actions taken by the user, and likely interests of the user by identifying (i) voice actions, each associated with a physical action, related to at least one topic associated with the entity that is indicated by user profile data associated with the user as being of interest to the user and (ii) for each of the voice actions related to the at least one topic, a frequency indicated by the user profile data that the user has initiated the physical action associated with the voice action in connection with the entity or another entity that is characterized as similar to the entity;
prompting, by the automated text-to-speech synthesizer, the user to select a voice action from among the voice actions of the subset;
in response to prompting the user, receiving, by the automated text-to-speech synthesizer, data identifying a selected voice action;
in response to receiving the data identifying the selected voice action, generating by the automated text-to-speech synthesizer a suggested voice command for performing the physical action associated with the selected voice action in relation to the entity that is referenced by the transcription of the utterance; and
providing, by the automated text-to-speech synthesizer, a synthesized speech representation of the suggested voice command for output to the user.

9. (canceled)

10. (canceled)

11. The system of claim 8, wherein determining a subset of the voice actions that are pre-associated with the entity based on user profile data associated with the user that indicates past usage of voice actions, past physical actions taken by the user, and likely interests of the user by identifying (i) voice actions, each associated with a physical action, related to at least one topic associated with the entity and that is indicated by user profile data as being of interest to the user and (ii) for each of the voice actions related to the at least one topic, a frequency indicated by the user profile data that the user has initiated the physical action associated with the voice action in connection with the entity or another entity that is characterized as similar to the entity comprises:
determining a selection score for a voice action of the set of voice actions based on the user profile data; and
selecting the voice action from the set of voice actions for inclusion in the subset of the voice actions based on the selection score.

12. (canceled)

13. The system of claim 8, wherein the suggested voice command is a natural language phrase that includes trigger terms for performing the voice action, as well as a reference to the entity.

14. The system of claim 8, wherein the subset of the voice actions comprises only a single voice action.

15. A non-transitory computer-readable medium storing instructions executable by one or more computers which, upon such execution, cause the one or more computers to perform operations comprising:
receiving, by an automated text-to-speech synthesizer, an utterance spoken by a user, the utterance including a reference to an entity and no reference to any particular voice action that is associated with a physical action;
determining, by the automated text-to-speech synthesizer, a set of voice actions that are pre-associated in a knowledge base with the entity that is referenced by a transcription of the utterance, wherein the voice actions are pre-associated with the entity based on queries that were submitted by one or more other users, machine-learning results, or manually-created associations;
determining, by the automated text-to-speech synthesizer, a subset of the voice actions that are pre-associated with the entity based on user profile data associated with the user that indicates past usages of voice actions, past physical actions taken by the user, and likely interests of the user by identifying (i) voice actions, each associated with a physical action, related to at least one topic associated with the entity that is indicated by user profile data associated with the user as being of interest to the user and (ii) for each of the voice actions related to the at least one topic, a frequency indicated by the user profile data that the user has initiated the physical action associated with the voice action in connection with the entity or another entity that is characterized as similar to the entity;
prompting, by the automated text-to-speech synthesizer, the user to select a voice action from among the voice actions of the subset;
in response to prompting the user, receiving, by the automated text-to-speech synthesizer, data identifying a selected voice action;
in response to receiving the data identifying the selected voice action, generating, by the automated text-to-speech synthesizer, a suggested voice command for performing the physical action associated with the selected voice action in relation to the entity that is referenced by the transcription of the utterance; and
providing, by the automated text-to-speech synthesizer, a synthesized speech representation of the suggested voice command for output to the user.

16. (canceled)

17. (canceled)

18. The medium of claim 15, wherein determining a subset of the voice actions that are pre-associated with the entity based on user profile data associated with the user that indicates past usage of voice actions, past physical actions taken by the user, and likely interests of the user by identifying (i) voice actions, each associated with a physical action, related to at least one topic associated with the entity and that is indicated by user profile data as being of interest to the user and (ii) for each of the voice actions related to the at least one topic, a frequency indicated by the user profile data that the user has initiated the physical action associated with the voice action in connection with the entity or another entity that is characterized as similar to the entity comprises:
determining a selection score for a voice action of the set of voice actions based on the user profile data; and
selecting the voice action from the set of voice actions for inclusion in the subset of the voice actions based on the selection score.

19. (canceled)

20. The medium of claim 15, wherein the suggested voice command is a natural language phrase that includes trigger terms for performing the voice action, as well as a reference to the entity.

21. (canceled)

22. The method of claim 1, comprising:
in response to receiving the data identifying the selected voice action, updating the user profile data associated with the user to increase the frequency, indicated by the user profile data, that the user has initiated the voice action in connection with the entity.

23. The method of claim 1, wherein determining a subset of the voice actions that are pre-associated with the entity based on user profile data associated with the user that indicates past usage of voice actions, past physical actions taken by the user, and likely interests of the user by identifying (i) voice actions, each associated with a physical action, related to at least one topic associated with the entity and that is indicated by user profile data as being of interest to the user and (ii) for each of the voice actions related to the at least one topic, a frequency indicated by the user profile data that the user has initiated the physical action associated with the voice action in connection with the entity or another entity that is characterized as similar to the entity comprises:
determining the subset of voice actions that are pre-associated with the entity based at on (i) an amount of content connected with the entity in a content library of the user and (ii) for each of the voice actions, the frequency indicated by the user profile data associated with the user that the user has initiated the physical action associated with the voice action in connection with the entity or another entity that is characterized as similar to the entity.
